(19) United States
(12) Patent Application Publication
(10) Pub. No.: US 2006/0212650 A1
(43) Pub. Date: Sep. 21, 2006

(54) Information recording medium, recording/reproducing apparatus, and recording/reproducing method

(75) Inventors: Sung-hee Hwang, Suwon-si (KR); Jung-wan Ko, Suwon-si (KR); Kyung-geun Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/378,394

(22) Filed: Mar. 20, 2006

(30) Foreign Application Priority Data
Mar. 21, 2005 (KR) 2005-23248

(51) Int. Cl. G06F 12/00

(52) U.S. Cl. 711/112

(57) ABSTRACT

A recording/reproducing apparatus includes a writing/reading unit that writes data to a write-once information recording medium and reads data from the medium; and a control unit that controls the writing/reading unit to write data to the medium so that the medium includes at least one border, controls the writing/reading unit to perform a logical overwrite (LOW) in the medium, and controls the writing/reading unit to write last border information at a time of closing an associated border of the medium in at least one last border information area of the medium. The last border information includes information on the LOW performed by the writing/reading unit.

### CROSS-REFERENCE TO RELATED APPLICATION

This application claims the benefit of Korean Patent Application No. 2005-23248 filed on Mar. 21, 2005 in the Korean Intellectual Property Office, the disclosure of which is incorporated herein in by reference in its entirety.

### BACKGROUND OF THE INVENTION

1. Field of the Invention

Aspects of the present invention relate to a disk, and more particularly to an information recording medium, a recording/reproducing apparatus, and a recording/reproducing method which can efficiently manage management information based on a logical overwrite.

2. Description of the Related Art

In a rewritable information recording medium, a spare area is generally provided in a part of a data area to manage defects. That is, when a defect is found in the course of recording user data in a user data area (an area of the data area other than the spare area) or reproducing the data recorded in the user data area, replacement data for replacing the defective data is written in the spare area.

In addition, in a write-once information recording medium, such a defect managing method is used for a logical overwrite (LOW). A “logical overwrite” is a method for making the write-once information recording medium behave like the rewritable information recording medium. That is, in order to update the data already recorded in the user data area, the recorded data is treated as if it is defective data, and replacement data for replacing the recorded data is recorded in a non-recorded area. In this way, by fixing a logical address of the data already recorded in the user data area and using a physical address corresponding to the logical address as an address of the replacement data, a host perceives that the data already recorded in the user data area has been rewritten at the same position, thereby facilitating data management. This is because the host uses only the logical address.

Now, the replacement of data by an LOW will be described with reference to the accompanying drawings.

FIG. 1 is a diagram illustrating a conventional replacement of data by an LOW. Referring to FIG. 1, when the host gives a recording instruction to physical spaces P1, P2, and P3 so as to update data blocks A1, A2, and A3 with data B1, B2, and B3, respectively, using an LOW in a state where the data blocks A1, A2, and A3 are recorded in the physical spaces P1, P2, and P3 in a recording medium, a drive system records the data B1, B2, and B3 in physical spaces P4, P5, and P6 in a non-recorded area of the user data area of the recording medium. The recording is through the replacement of data by the LOW and generates a replacement entry indicating a state where P1, P2, and P3 are replaced with P4, P5, and P6, respectively. When the host gives a reproducing instruction to the logical address corresponding to the original location in order to read the data B1, B2, and B3, the drive system reproduces the data recorded in P4, P5, and P6 in the recording medium through the replacement entry and transmits the reproduced data to the host.

However, in a write-once information recording medium and apparatus such as a conventional DVD-R, the user data area of the disk is divided into one or more R-zones so as to write the data, and the disk is used in a disk at once mode (when the number of the R-zones is one) or an incremental recording mode in which recording can be successively performed in each of the R-zones.

Recently, 15-25 GB capacity high-density disks have appeared. A method such as the LOW has been tried on these high-density write-once information recording mediums, in addition to using the incremental recording mode.

Since the LOW must be performed in a write-once information recording medium such as a DVD-R or the like, a replacement list (RPL) containing information on the LOW is required. The RPL must be managed together with recording management data (RMD) for recording management so that the medium can be smoothly and efficiently used.

### SUMMARY OF THE INVENTION

An aspect of the invention provides an information recording medium, a recording/reproducing apparatus, and a recording/reproducing method that can manage recording management data (RMD) for managing recorded data and a replacement list (RPL) required for performing a logical overwrite in a write-once recording medium.

According to an aspect of the invention, there is provided a write-once information recording medium including a lead-in area; at least one border; a border closing area in the lead-in area; a border-out area in a first border and any border subsequent to the first border; a border-in area in any border subsequent to the first border; and at least one last border information area used by a recording/reproducing apparatus to write last border information at a time of closing an associated border, the last border information including information on a logical overwrite (LOW) performed by the recording/reproducing apparatus in the medium; wherein a last border information area for the first border is provided in the border closing area of the lead-in area and/or the border-out area of the first border; and wherein a last border information for any border subsequent to the first border is provided in the border-in area of any border subsequent to the first border and/or the border-out area of any border subsequent to the first border.

According to an aspect of the invention, there may be no border subsequent to the first border, such that the medium may be a single-border medium.

According to an aspect of the invention, there may be at least one border subsequent to the first border, such that the medium may be a multi-border medium.

According to an aspect of the invention, the last border information may include at least one copy of last recording management data (RMD) at the time of closing the associated border and/or at least one copy of a last replacement list (RPL) at the time of closing the associated border, the last RPL including information on any replacement of data by the LOW performed by the recording/reproducing apparatus up to the time of closing the associated border.

According to an aspect of the invention, the last border information may include multiple copies of the last RMD and/or multiple copies of the last RPL. The last RMD may include location information of a copy of the last RPL. The last RPL may further include defect information for replacement of defective data performed by the recording/reproducing apparatus in the medium up to the time of closing the associated border.

According to another aspect of the invention, there is provided a recording/reproducing apparatus that writes data to a write-once information recording medium and/or reproduces data from the medium, the medium including a lead-in area, the apparatus including a writing/reading unit that writes data to the medium and reads data from the medium; and a control unit that controls the writing/reading unit to write data to the medium so that the medium further includes at least one border, a border closing area in the lead-in area, a border-out area in a first border and any border subsequent to the first border, and a border-in area in any border subsequent to the first border, controls the writing/reading unit to perform a logical overwrite (LOW) in the medium, and controls the writing/reading unit to write last border information at a time of closing an associated border in at least one last border information area, the last border information including information on the LOW performed by the writing/reading unit; wherein a last border information area for the first border is provided in the border closing area of the lead-in area and/or the border-out area of the first border; and wherein a last border information area for any border subsequent to the first border is provided in the border-in area of any border subsequent to the first border and/or the border-out area of any border subsequent to the first border.

According to an aspect of the invention, the control unit may further control the writing/reading unit to write, as the last border information, at least one copy of last recording management data (RMD) at the time of closing the associated border and/or at least one copy of a last replacement list (RPL) at the time of closing the associated border, the last RPL including information on any replacement of data by the LOW performed by the writing/reading unit up to the time of closing the associated border.

According to another aspect of the invention, there is provided a recording/reproducing method of writing data to a write-once information recording medium and/or reproducing data from the medium, the medium including a lead-in area, the method including writing data to the medium so that the medium includes at least one border, a border closing area in the lead-in area, a border-out area in a first border and any border subsequent to the first border, and a border-in area in any border subsequent to the first border; performing a logical overwrite (LOW) in the medium; and writing last border information at a time of closing an associated border in at least one last border information area, the last border information including information on the LOW performed in the medium; wherein a last border information area for the first border is provided in the border closing area of the lead-in area and/or the border-out area of the first border; and wherein a last border information area for any border subsequent to the first border is provided in the border-in area of any border subsequent to the first border and/or the border-out area of any border subsequent to the first border.

According to an aspect of the invention, the method may further include reading the last border information from the last border information are for the first border and any border subsequent to the first border; and reproducing data from the first border and any border subsequent to the first border with reference to the last border information read in the reading of the last border information.

According to another aspect of the invention, there is provided a computer-readable medium encoded with processing instructions for implementing a recording/reproducing method, performed by a computer, of writing data to a write-once information recording medium and/or reproducing data from the medium, the medium including a lead-in area, the method including writing data to the medium so that the medium further includes at least one border, a border closing area in the lead-in area, a border-out area in a first border and any border subsequent to the first border, and a border-in area in any border subsequent to the first border; performing a logical overwrite (LOW) in the medium; and writing last border information at a time of closing an associated border in at least one last border information area, the last border information including information on the LOW performed in the medium; wherein a last border information area for the first border is provided in the border closing area of the lead-in area and/or the border-out area of the first border; and wherein a last border information area for any border subsequent to the first border is provided in the border-in area of any border subsequent to the first border and/or the border-out area of any border subsequent to the first border.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a conventional logical overwrite (LOW)-based replacement;

FIG. 2 is a block diagram illustrating a recording/reproducing apparatus according to an embodiment of the present invention;

FIG. 3 is a detailed block diagram of the recording/reproducing apparatus illustrated in FIG. 2;

FIG. 4 is a diagram illustrating a structure of an information recording medium for illustrating an area of a medium in which a replacement list (RPL) is recorded according to an embodiment of the present invention;

FIG. 5A illustrates an example of an RPL format according to an embodiment of the present invention;

FIG. 5B illustrates an example of an RPL entry illustrated in FIG. 5A;

FIG. 5C illustrates an example of the RPL format illustrated in FIG. 5A when the RPL includes two blocks;

FIG. 6A illustrates an example of an RPL format according to another embodiment of the present invention;

FIG. 6B illustrates an example of the RPL format illustrated in FIG. 6A when the RPL includes two blocks;

FIG. 7 is a diagram illustrating a structure of an information recording medium for illustrating an example of recording the RPL from a last recorded address (LRA) of an R-zone that was opened last according to an embodiment of the present invention;

FIG. 8 illustrates an example of an RMD format according to an embodiment of the present invention;

FIG. 9 illustrates an example of a recording method according to an embodiment of the present invention;

FIG. 10 illustrates an example of a reproducing method according to an embodiment of the present invention;

FIG. 11 is a diagram illustrating an area for recording last border information when closing a first border of a disk according to an embodiment of the present invention;

FIG. 12 is a diagram illustrating an area for recording last border information when closing a second border of a disk according to an embodiment of the present invention;

FIG. 13 is a flowchart illustrating a method of recording last border information when closing borders of a disk according to an embodiment of the present invention; and

FIG. 14 is a flowchart illustrating a method of reproducing data with reference to last border information recorded when borders of a disk were closed according to an embodiment of the present invention.

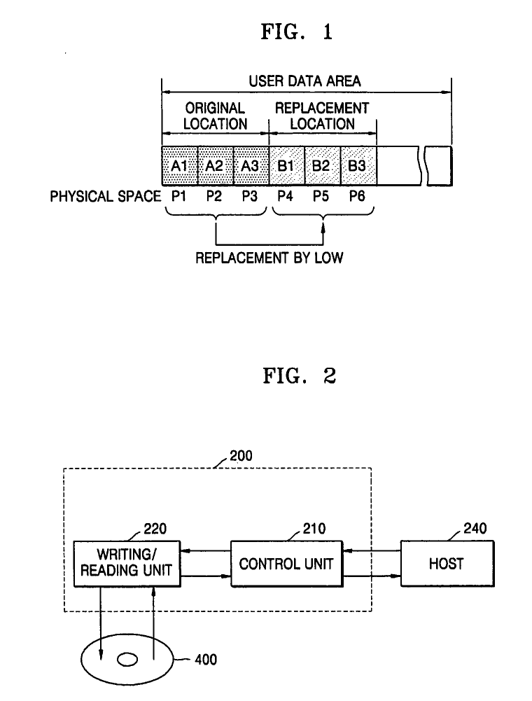

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

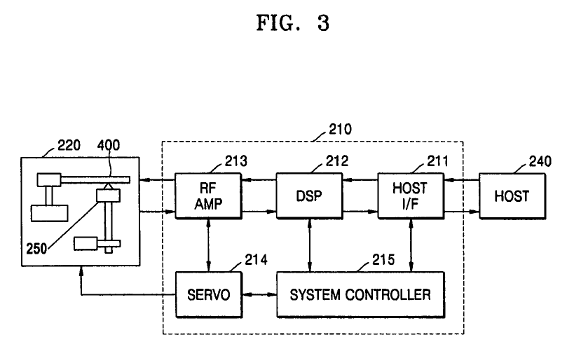

FIG. 2 is a block diagram illustrating a recording/reproducing apparatus 200 according to an embodiment of the present invention. Referring to FIG. 2, the recording/reproducing apparatus 200 includes a writing/reading unit 220 and a control unit 210. The control unit 210 is connected to a host 240. The writing/reading unit 220 writes data to a disk 400, which is an information recording medium according to the present embodiment, under control of the control unit 210 and reads the written data to reproduce the data. The control unit 210 controls the writing/reading unit 220 to write data in blocks of predetermined recording units or processes the data read by the writing/reading unit 220 to obtain effective data.

According to the shown embodiment, the control unit 210 can perform a logical overwrite (LOW) on the disk 400, which is a write-once recording medium, to update data written to the disk 400 as if the write-once recording medium were a rewritable recording medium.

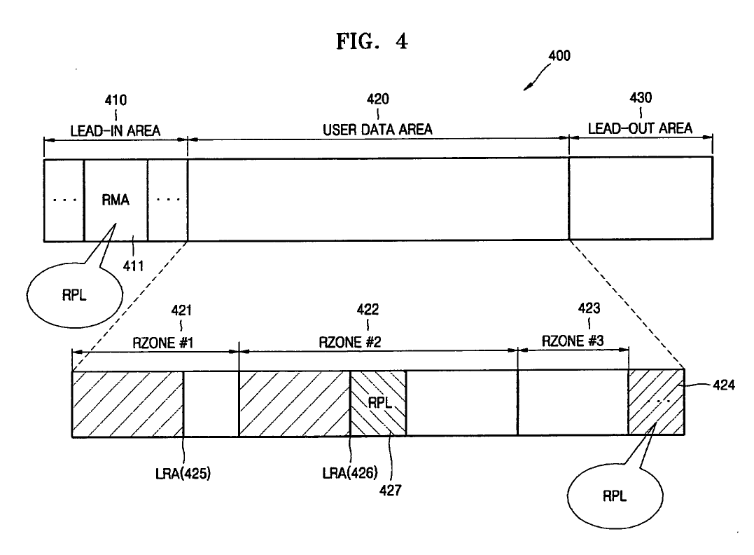

FIG. 3 is a detailed block diagram of the recording/reproducing apparatus illustrated in FIG. 2. Referring to FIG. 3, the writing/reading unit 220 includes a pickup 250. The disk 400 is mounted on the pickup 250. The control unit 210 includes a host I/F 211, a DSP 212, an RF amp 213, a servo 214, and a system controller 215. The host I/F 211 receives a data write command from the host 240 and transmits it to the system controller 215.

The system controller 215 receives the data write command from the host I/F 211 and initializes the data writing process. The system controller 215 controls the pickup 250 so that a replacement list (RPL) containing information on a replacement of data by the LOW is written in one or more of a user data area of the disk 400, a recording management area (RMA) of the disk 400, a specific writable area of the disk 400, or combinations thereof. The system controller 215 controls the pickup 250 so as to insert location information of RPL blocks containing the RPL into recording management data (RMD) and write the recording management data in the recording management area.

Furthermore, when each border is closed in the course of using the disk 400 as a disk including at least one border, the system controller 215 controls the pickup 250 so that last border information at the time of closing each border is written in one or more of a border closing area of a lead-in area, a border-in area of a border zone, and a border-out area of the border zone. The last border information may include a copy of one or more of the last recording management data at the time of closing the border and a last RPL of RPLs having the information on the replacement of data by an LOW.

The DSP 212 adds error correcting data such as parity data or the like so as to correct the data to be written which is input through the host I/F 211, performs ECC encoding, generates an ECC block as an error correcting block, and then modulates the ECC block in a predetermined manner. The RF amp 213 converts the data output from the DSP 212 into an RF signal. The pickup 250 writes the RF signal output from the RF amp 213 to the disk 400. The servo 214 receives an instruction necessary for servo control from the system controller 215 and performs servo control of the pickup 250.

At the time of reproduction, the host I/F 211 receives a read command from the host 240. The system controller 215 performs an initialization for reproduction.

The system controller 215 controls the writing/reading unit 220 so that the recording management data written in a predetermined area of the disk 400 is read. Also, the system controller 215 controls the pickup 250 so that location information of each of the RPL blocks is obtained from the recording management data and the RPL is read from one or more of the user data area provided in the disk 400, the recording management area, and the specific writable area of the disk 400 with reference to the obtained location information, and controls the pickup 250 so that the data is read from the disk 400 with reference to the read RPL.

The system controller 215 controls the pickup 250 so that the last border information of each border is read from one or more of the border closing area of the lead-in area of the medium, the border-in area of the border zone, and the border-out area of the border zone, and controls the pickup so that the data written in each border is reproduced with reference to the read last border information.

The pickup 250 irradiates laser beams to the disk 400, receives the laser beams reflected from the disk 400, and then outputs an obtained optical signal. The RF amp 213 converts the optical signal output from the pickup 250 into an RF signal, supplies modulated data obtained from the RF signal to the DSP 212, and supplies a control servo signal obtained from the RF signal to the servo 214. The DSP 212 demodulates the modulated data and outputs data obtained through ECC error correction.

The servo 214 receives the control servo signal from the RF amp 213 and receives instructions necessary for the servo control from the system controller 215 and performs servo control of the pickup 250. The host I/F 211 transmits the data output from the DSP 212 to the host 240.

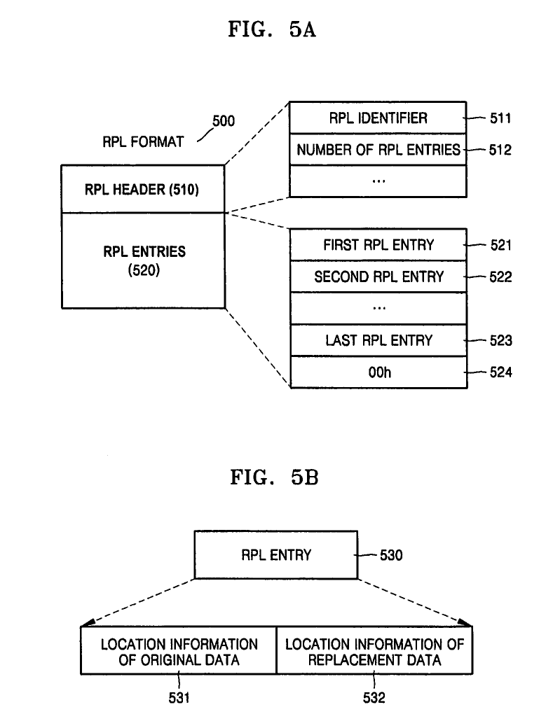

FIG. 4 is a diagram illustrating a structure of an information recording medium 400 for illustrating an area of the medium in which an RPL is recorded according to an embodiment of the present invention. Referring to FIG. 4, the information recording medium 400 according to the present embodiment includes a lead-in area 410, a user data area 420, and a lead-out area 430 which are successively provided. The lead-in area 410 includes a recording management area (RMA) in which recording management data for managing the data recorded in the user data area 420 is recorded.

The user data area 420 includes a plurality of R-zones. As shown, the R-zones include RZONE #1 421, RZONE #2 422, and RZONE #3 423. Data is written in a portion of the RZONE #1 421 and a last recorded address (LRA) therein is denoted by a reference numeral 425. Also, data is recorded in a portion of the RZONE #2 422 and a last recorded address (LRA) therein is denoted by a reference numeral 426.

Furthermore, as shown, a portion of the user data area 420 is allocated as an area for writing special-purpose data 424 in FIG. 4. User data is not written in the special-purpose data area 424. However, the area 424 need not be used in all aspects of the invention.

In the information recording medium 400 according to the present embodiment, an RPL can be recorded in the user data area 420. In FIG. 4, an RPL 427 is recorded next to the last recorded address 426 of RZONE #2 422. When the RPL 427 is recorded in the user data area 420, a last LRA of the LRAs of the R-zones or an LRA of an open R-zone is recorded first when RPL entries are updated and then the RPL is updated. However, the open R-zone can be otherwise recorded.

In addition, the RPL according to the present embodiment is be recorded in a recording management data (RMD) field in an RMA 411 provided in the lead-in area 410. Alternatively, the RMA 411 may be provided in an area other than the lead-in area 410. For example, the RMA 411 may be provided in an R-information area provided outside the lead-in area of a disk such as a DVD-R.

According to the shown embodiment, the RPL is recorded in a specific area for recording only the RPL. As illustrated in FIG. 4, a portion of the user data area 420 is allocated to the space 424 for recording the RPL and may be used for recording the RPL instead of the user data. However, the RPL can be recorded in other areas in other aspects of the invention.

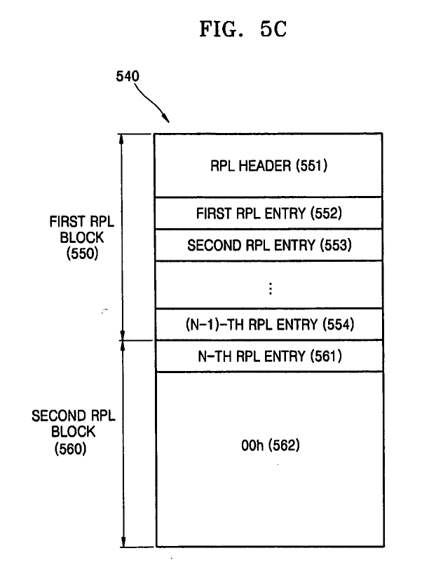

FIG. 5A illustrates an example of an RPL format 500 according to an embodiment of the present invention. Referring to FIG. 5A, the RPL format 500 includes an RPL header 510 and RPL entries 520. The RPL header 510 contains general information on the RPL, and each of the RPL entries 520 contains information on a replacement of data by an LOW. The RPL header 510 includes an RPL identifier 511 identifying the RPL and a number of RPL entries 512.

The RPL entries 520 include a first RPL entry 521, a second RPL entry 522, . . . , and a last RPL entry 523, and a space 524 is filled with “00h”.

FIG. 5B illustrates an example of one of the RPL entries illustrated in FIG. 5A. Referring to FIG. 5B, an RPL entry 530 includes location information of original data 531 before the replacement of data by the LOW and location information of replacement data 532. The RPL entry 530 may further include information on the number of units which are successively replaced and an information field of the replacement units (for example, indicating whether the replacement units are sectors or blocks). A drive system can reproduce a sector or a block which is replaced using the LOW from the RPL entries.

The RPL has a size of one or more sectors up to a predetermined maximum size (multiple sectors). That is, the size of the RPL is changed according to the number of the RPL entries. When the size of the RPL is defined as a multiple of blocks (for example, each block includes 16 sectors or 32 sectors), if the maximum size is three recording/reproducing blocks, the size of the RPL may be one block, two blocks, or three blocks. Also, when the size of the RPL is defined as a multiple of sectors (for example, each sector includes 2048 bytes), the size of the RPL may range from one sector to three blocks. The reason why the size is changed is so only required information may be written so that an unnecessary area is prevented from being generated, since a new area is required when updating information by the characteristics of the write-once information recording medium.

FIG. 5C illustrates an example of the RPL format illustrated in FIG. 5A when the RPL according to the present embodiment includes two blocks. Referring to FIG. 5C, an RPL 540 includes a first RPL block 550 and a second RPL block 560. The first RPL block 550 includes an RPL header 551, a first RPL entry 552, a second RPL entry 553, . . . , and an (N−1)-th RPL entry 554. The second RPL block 560 includes an N-th RPL entry 561, and a non-recorded area 562 is filled with “00h”.

If an (N+1)-th RPL entry is added to the RPL 540, the first RPL block 550 and the second RPL block 560 are newly recorded in an area in which the RPL can be recorded with the (N+1)-th entry being written in a location next to the N-th RPL entry 561 in the newly recorded second block.

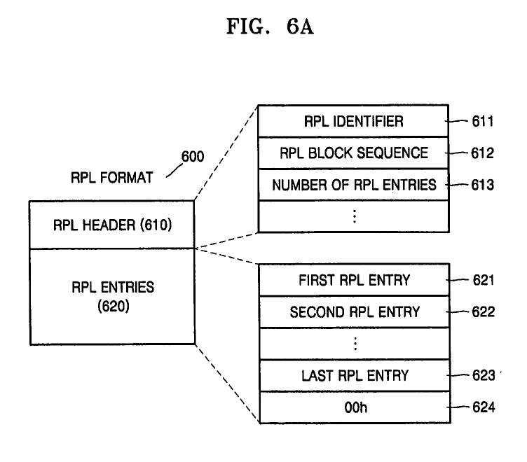

FIG. 6A illustrates an example of an RPL format according to another embodiment of the present invention. Referring to FIG. 6A, an RPL format 600 includes an RPL header 610 and RPL entries 620. The RPL header 610 contains general information on the RPL, and each of the RPL entries 620 contains information on a replacement of data by an LOW. The RPL header 610 includes an RPL identifier 611 identifying the RPL, an RPL block sequence 612, and a number of RPL entries 613. The RPL block sequence 612 identifies the position of an RPL block in a sequence of two or more RPL blocks of one RPL. Each RPL block contains RPL header information if the RPL includes two or more RPL blocks. The RPL entries 620 include a first RPL entry 621, a second RPL entry 622, . . . , and a last RPL entry 623, and a non-recorded area 624 is filled with “00h”.

Similar to the example illustrated in FIG. 5A, the RPL has a size of one or more sectors within a predetermined maximum size (multiple sectors). That is, the size of the RPL is changed according to the number of the RPL entries. When the size of the RPL is defined as a multiple of blocks (for example, each block includes 16 sectors or 32 sectors), if the maximum size is three recording/reproducing blocks, the size of the RPL may be one block, two blocks, or three blocks. Also, when the size of the RPL is defined as a multiple of sectors (for example, each sector includes 2048 bytes), the size of the RPL may range from one sector to three blocks. The reason why the size is changed is so only required information may be written so that an unnecessary area is prevented from being generated, since a new area is required when updating information by the characteristics of the write-once information recording medium.

In addition, the RPL format 600 illustrated in FIG. 6A indicates the RPL format of each RPL block, unlike the RPL format 500 illustrated in FIG. 5A. Each RPL block includes an RPL header containing the RPL identifier, the RPL block sequence, and the number of RPL entries. For example, if the RPL is recorded in three recording/reproducing blocks, a first sector of the RPL in each of the recording/reproducing blocks includes the RPL header. The RPL entries are recorded in a location next to the RPL header.

FIG. 6B illustrates an example of the RPL format illustrated in FIG. 6A when the RPL has a size defined as a multiple of a blocks and includes two blocks. Referring to FIG. 6B, an RPL 630 includes a first RPL block 640 and a second RPL block 650. The first RPL block 640 includes an RPL header 641, a first RPL entry 642, a second RPL entry 643, . . . , and an (N−1)-th RPL entry 644. The second RPL block 650 includes an RPL header 651 and an N-th RPL entry 652, and a non-recorded area 653 is filled with “00h”. In the RPL header 641 of the first RPL block 640, “1” is written as an RPL block sequence 645, and, in the RPL header 651 of the second RPL block 650, “2” is written as an RPL block sequence 654.

In the example illustrated in FIG. 6B, since the RPL header is written in each RPL block, the available space for writing the RPL entries is reduced. However, since the RPL header information is included in each RPL block, reliability of the RPL header information can be improved.

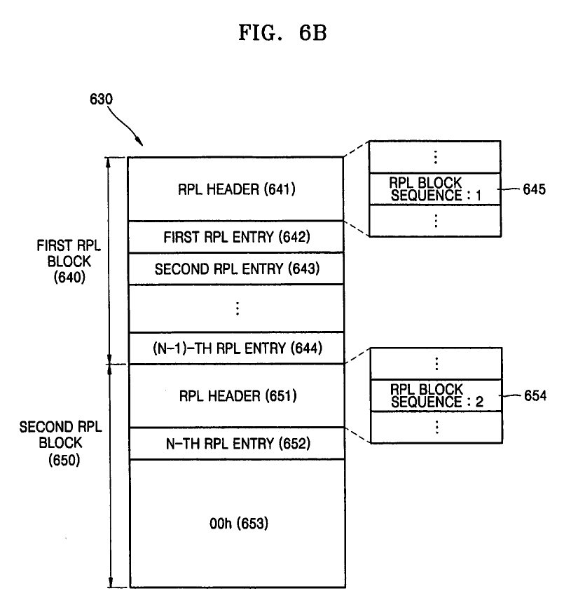

FIG. 7 is a diagram illustrating a structure of an information recording medium 700 for illustrating an example of recording an RPL from an LRA of an R-zone (RZONE) that was opened last according to an embodiment of the present invention. Referring to FIG. 7, the information recording medium 700 includes a lead-in area 710, a user data area 720, and a lead-out area 730 which are successively provided. The lead-in area 710 includes an RMA 711 and the user data area 720 includes an RZONE #1 721, an RZONE #2 722, and an RZONE #3 723.

Before the RPL is updated, two RPL blocks 725 are recorded ending at a last recorded address (LRA) 726 of the RZONE #2 722 of the user data area 720, RMDs 712 are recorded in the RMA 711 of the lead-in area 710, and include a last RMD 713 at the end of the recorded RMDs 712. The RMD 713 contains location information of the two RPL blocks 725 recorded according to the present embodiment.

Data 727 is added to the RZONE #3 723, and a drive system writes the replacement data in a writable area 728 in the RZONE #2 722 in response to an command of a host, which performs an LOW in an area of the RZONE # 2 722 in which the recording was previously performed. When the data 727 is added, the RPL must be updated. Accordingly, the drive system records three RPL blocks 729 from the LRA of the RZONE #3 723 which is a last LRA of the LRAs in the open R-zone and records an updated RMD 714 in the RMA 711 after the last RMD 713 of the recorded RMDs 712 in consideration of the change of the location information of the RPL blocks due to the updated RPL and the change of the states of the R-zones. At this time, the updated RMD 714 contains location information of the three RPL blocks 729 as the location information of the updated RPL.

When the RPL is recorded in the RMD field, it is preferable, but not required, that the area of the RMD field except the area for the information of the RMD format is used for recording the RPL. In this case, when the space of the RMD field is insufficient, any RPL which is generated after the RMD field has been filled up may be recorded in the user data area as blocks of other recording/reproducing units.

When a writable separate area for recording the RPL is provided, the separate area may also be provided in the lead-in area or the lead-out area. If the space of the lead-in area or the lead-out area is insufficient, a portion of the user data area may be allocated to the area for recording the RPL at an initialization time. The area for recording the RPL may be successively used in ascending order or descending order of the physical address. Also, when confirming a location in which the updated RPL is recorded, the location information of the RPL may be provided in the RMD when the RPL is recorded in the user data area, the RMA, or the separate area.

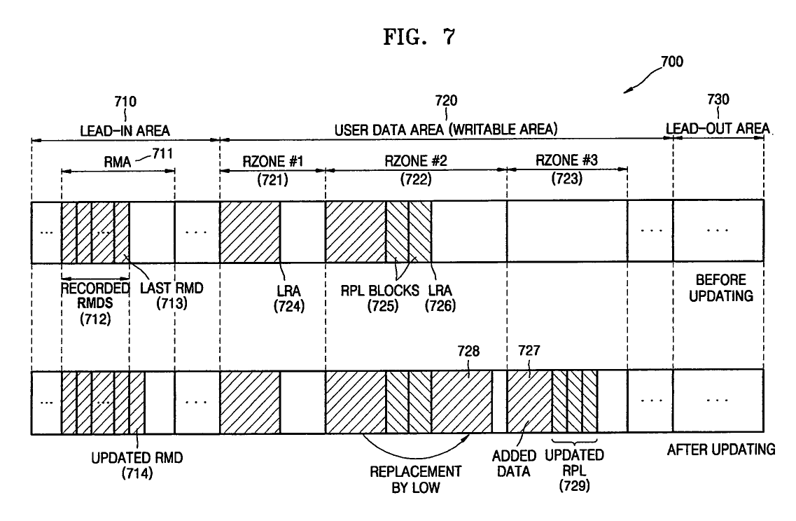

FIG. 8 illustrates an example of an RMD format according to an embodiment of the present invention, and illustrates location information of an RPL in an RMD format 800 when the RPL can be recorded in at most N blocks. The recording management data (RMD) is information for generally managing the disk and includes information on recording/reproduction, information on replacement of data by an LOW, and information on a defect process. Referring to FIG. 8, the RMD format 800 includes an RMD field 810 containing general information on data recording management and an RMD field 820 containing RZONE information on individual information of each of a plurality of R-zones provided in a user data area.

The RMD field 810 includes a number of RPL blocks 811, location information of a first RPL block 812, location information of a second RPL block 813, . . . , and location information of an N-th RPL block 814.

The number of RPL blocks 811 indicates the number of the blocks in which the last RPL is actually recorded. For example, if the RPL is recorded in two blocks, this field is set to “2”.

The location information of the first RPL block 812 indicates a physical address of a first sector in which the RPL is recorded in the block as the location information of the first block in which the RPL is contained. Similar to the case where the RPL is recorded in the RMD field, since the RPL can be recorded in an intermediate sector of the block, not necessarily the first sector, the physical address of the first sector in which the RPL is recorded is indicated. If the RPL is constructed as illustrated in FIG. 6A and the RPL format includes the RPL block sequence, the RPL header exists in the sector indicated by the physical address and the RPL block sequence in the RPL header information indicates “1”. The location information of the second RPL block 813, . . . , and the location information of the N-th RPL block 814 are indicated using the same method.

In the information field in which the RPL is not recorded, “00h” is set. The number of RPL blocks 811 may be omitted from the RMD format illustrated in FIG. 8. However, when the number of RPL blocks 811 is included, the number of the blocks including the RPL which is actually recorded, the value of the number of RPL blocks 811, and the number of the fields for the location information of the block including the recorded RPL must be equal to one another. For example, if the number of the blocks in which the RPL is actually recorded is three, the number of RPL blocks 811 is set to “3” and the location information other than the first location information, the second location information, and the third location information of the N pieces of the location information of the RPL block is set to “00h”.

Since the location information of the block including the RPL is managed in the RMD, the RMD is read when the disk is loaded in the drive system and thus the location information of the RPL can be rapidly found. That is, since the RMD includes RZONE information and the information on recording/reproduction such as a recording mode, the drive system first accesses the RMD and manages the location information of the RPL in the RMD to more rapidly obtain the RPL. Further, when the location information of each RPL block is managed and the RPL entries are updated to update the RPL, only the blocks which have to be updated can be updated and the area for updating the RPL can be efficiently used.

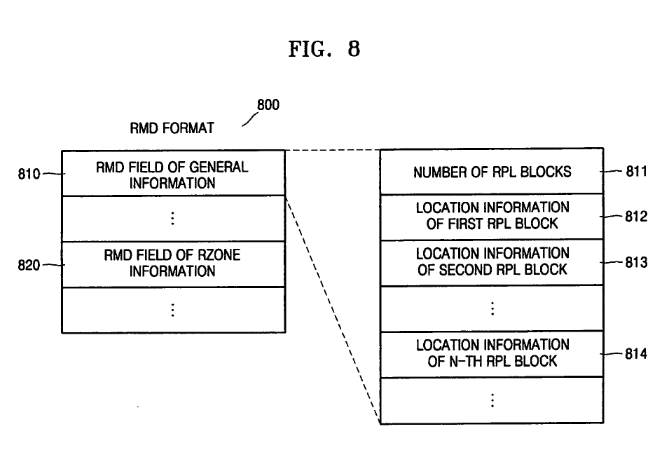

FIG. 9 is a flowchart illustrating a recording method according to an embodiment of the present invention. Referring to FIG. 9, first, a drive writes replacement data for replacing original data in a user data area of a disk using a logical overwrite (LOW) (operation 910). The drive generates a replacement list (RPL) containing information on a replacement of data by an LOW (operation 920). The RPL includes location information of the original data before the replacement of data by the LOW and location information of the replacement information after the replacement of data by the LOW.

The drive records the RPL in one or more of the user data area, a recording management area of a lead-in area of the disk, a specific writable area of the disk, or combinations thereof (operation 930).

Finally, information on the location in which the RPL is recorded is included in the recording management data and is recorded in the recording management area 411 (operation 940).

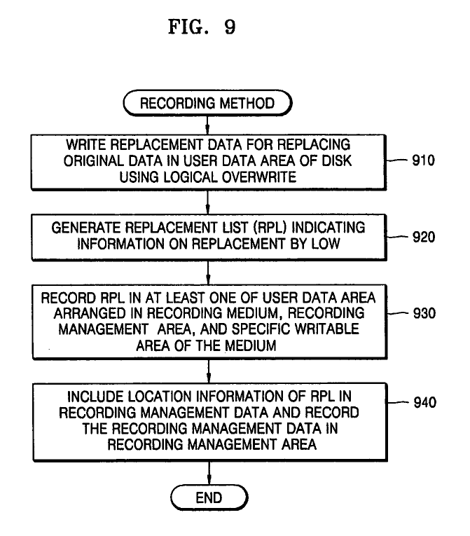

FIG. 10 is a flowchart illustrating a reproducing method according to an embodiment of the present invention. Referring to FIG. 10, first, a drive reads recording management data from a recording management area 411 provided in a disk 400 (operation 1010). The drive obtains the location information of each of a plurality of RPL blocks from the read recording management data (operation 1020).

An RPL is read from one or more of a user data area provided in the disk, the recording management area, a specific writable area of the disk, or combinations thereof, with reference to the location information of each of the RPL blocks (operation 1030).

The data is read from the disk with reference to the read RPL (operation 1040). Since the RPL has the location information of the original data and the location information of the replacement data replaced by an LOW, when a reproduction instruction for reproducing the original data is received from the host, the drive can obtain the location of the replacement data for replacing the original data from the RPL and thus the replacement data can be reproduced from the replacement location.

As mentioned above, when a border is closed in the course of using the disk based on the LOW, the last border information of the closed border must be recorded in a predetermined area of the disk.

According to the shown embodiment, when a first border of the disk is closed, the last RMD and the last RPL are recorded in a border closing area provided in the lead-in area of the disk. Also, for robustness, the last RMD and the last RPL may be recorded many times. In a DVD-R having a border zone, when the first border is closed, the last RMD and the last RPL are recorded in the border closing area provided in the lead-in area as well as the border-out area of the border zone. For robustness, the last RMD and the last RPL may also be recorded in the border-out area many times.

If the disk is used as a multi-border disk, the last RMD and the last RPL may be recorded in the border-in area or the border-out area of the border which will be closed after the first border. That is, when closing the border after the first border, the last RMD and the last RPL can be written in the border-in area and the border-out area of a current border. Also, for robustness, the last RMD and the last RPL may be recorded many times.

Since the last RMD and the last RPL are recorded in a certain area at the time of closing the border, the last RMD and the last RPL of the closed border can be rapidly accessed. Also, since the information is recorded many times, robustness can be ensured.

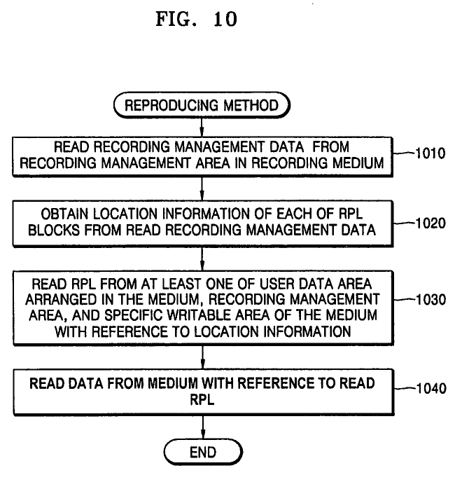

FIG. 11 is an explanatory diagram illustrating an area for recording last border information when closing a first border of a disk according to an embodiment of the present invention. Referring to FIG. 11, a disk 1100 includes a lead-in area 1110, a user data area 1120, and a lead-out area 1130 which are successively provided The lead-in area 1110 has an RMA 1140 and a border closing area 1150. When the writing of data 1121 is finished in the course of writing data using the user data area 1120 as one border, the border must be closed. To close the border, a last RMD and a last RPL constituting last border information are recorded in a border closing area 1150 of the lead-in area 1110. The last border information recorded in the border closing area 1150 includes a first copy of the last RMD 1151, a second copy of the last RMD 1152, . . . , and an N-th copy of the last RMD 1153, and a first copy of the last RPL 1154, a second copy of the last RPL 1155, . . . , and an M-th copy of the last RPL 1156. Also, in the DVD-R, the last border information may also be recorded in a border-out area 1122.

As illustrated in FIG. 11, when the last RMD and the last RPL are recorded in the border closing area 1150, the RMD may indicate the location information of each RPL block. Accordingly, the last RMD may be recorded in the border closing area 1150 after the last RPL is recorded. Also, as a method of indicating the location information of the RPL, the location information of each RPL block may correspond to the first copy of the last RPL indicating the RMD.

Furthermore, the border closing area 1150 is not limited to a space for recording only the last border information when closing the border, but may be used as an area for recording the RMD before closing the border. That is, the border closing area 1150 may be used both to record the RMD before closing the border and to record the last RMD and the last RPL when closing the border. Also, if necessary, it is possible to record only the last RMD in the border closing area and record the last RPL in a space for recording the RPL. This is because the last RMD contains the location information of the RPL, and thus the last RPL can be easily located using the last RMD. That is, according to the current embodiment of the present invention, the last RPL need not necessarily be recorded in the same area as the last RMD.

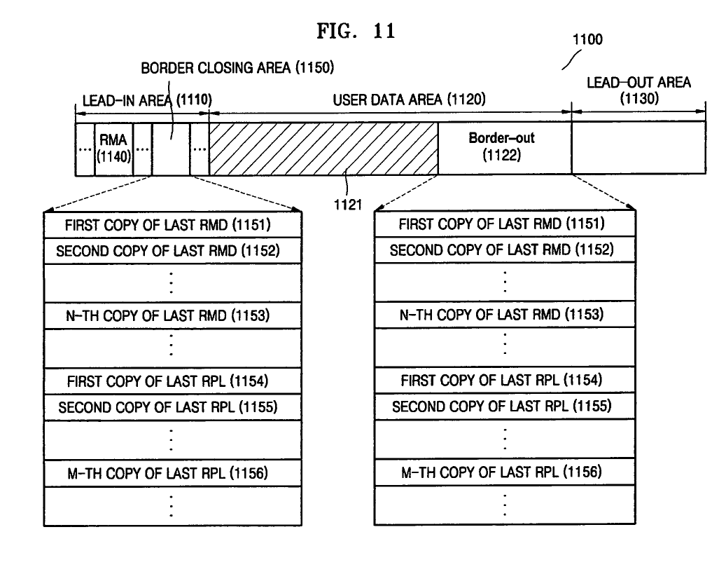

FIG. 12 is an explanatory diagram illustrating an area for recording last border information when closing a second border of a disk according to an embodiment of the present invention. Referring to FIG. 12, a disk 1200 includes a lead-in area 1210, a user data area 1220, and a lead-out area 1230 which are successively provided, and the user data area 1220 contains two closed borders. A first border 1240 includes a bordered area 1241 and a border-out area 1242, and a second border 1250 includes a current border-in area 1251, a bordered area 1252, and a current border-out area 1253. Each bordered area of the disk 1200 is followed by a border zone including a border-out of a preceding bordered area and a border-in of a succeeding bordered area (if any).

When the second border 1250 is closed, the last border information of the second border 1250 may be recorded in the current border-in area 1251 or the current border-out area 1253 of the second border 1250 as illustrated in FIG. 12. Similar to the first border 1240, the last RMD and the last RPL may be recorded many times. In FIG. 12, the last border information recorded in the current border-in area 1251 and the current border-out area 1253 includes a first copy of the last RMD 1261, a second copy of the last RMD 1262, . . . , and an N-th copy of the last RMD 1263, and a first copy of the last RPL 1264, a second copy of the last RPL 1265, . . . and an M-th copy of the last RPL 1266.

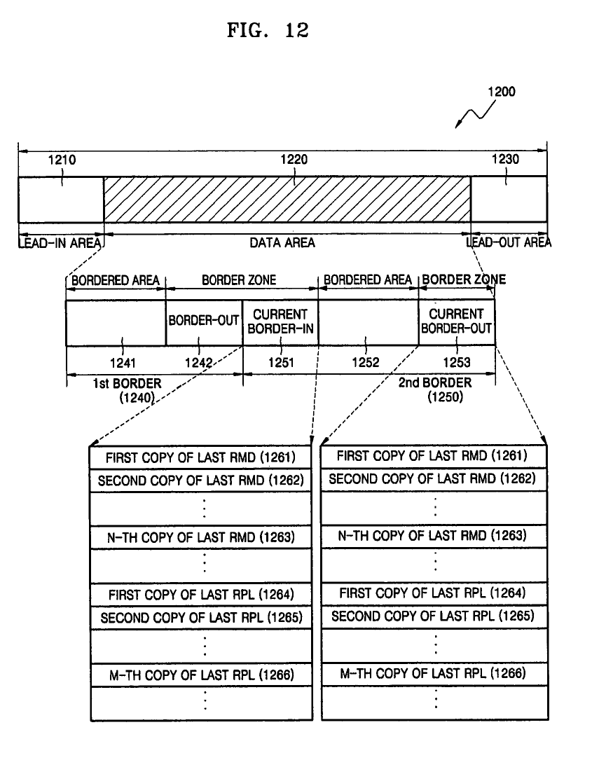

FIG. 13 is a flowchart illustrating a method of recording last border information when closing borders of a disk according to an embodiment of the present invention.

When closing the first border of the disk, the last RMD and the last RPL are recorded in one or more of a border closing area provided in the lead-in area of the disk and a border-out area of the first border at least one time (operation 1310). At this time, the last RPL may be recorded in another area. Also, the border closing area of the lead-in area may be a portion of an RMA provided in the lead-in area.

When closing the second border of the disk, the last RMD and the last RPL are recorded in the border-in area or the border-out area of the second border at least one time (operation 1320).

When the disk is used as a single-border disk, the operation 1320 is not performed.

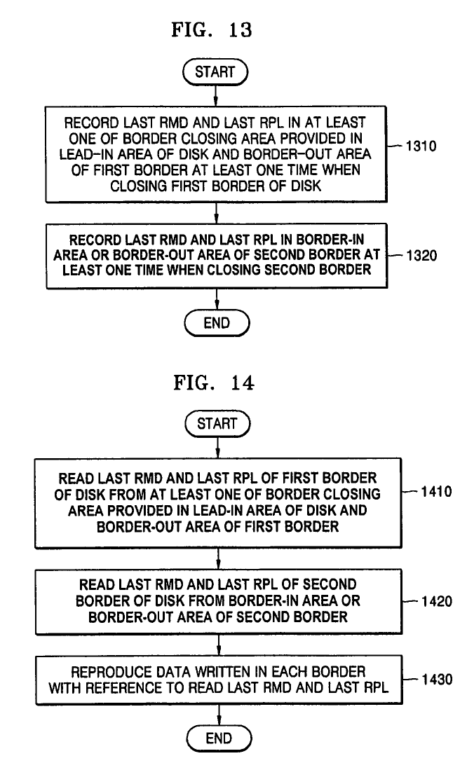

FIG. 14 is a flowchart illustrating a method of reproducing data with reference to last border information recorded when borders of a disk were closed according to an embodiment of the present invention.

The last RMD and the last RPL of the first border of the disk are read from one or more of a border closing area provided in a lead-in area of the disk and a border-out area of the first border (operation 1410). Alternatively, the last RPL may be read from an area other than the border closing area or the border-out area, in which case, although the last RMD and the last RPL are not recorded in the same area, the last RPL can be read using the location information of the last RPL, because the last RMD contains the location information of the last RPL.

The last RMD and the last RPL of the second border are read from the border-in area or the border-out area of the second border (operation 1420). When the disk is a single-border disk, the operation 1420 is not performed.

The data recorded in each border is reproduced with reference to the read last RMD and the last RPL (operation 1430). Since the last RMD contains the general information on the border record or the defect and the last RPL has the information on the replacement of data by an LOW, the drive refers to the last RMD and the last RPL so as to reproduce the data recorded in each border.

Although the replacement of data by an LOW is performed in the information recording medium according to an embodiment of the present invention, the present invention is not limited to this, and a defect-based replacement of data may also be performed. Accordingly, the RPL may include information on replacement of data by an LOW as well as information on defect-based replacement of data.

Aspects of the invention may also be embodied as computer-readable code on a computer-readable recording medium. The computer-readable recording medium may be any data storage device that can store data which can be thereafter read by a computer system. Examples of a computer-readable recording medium include read-only memory (ROM), random-access memory (RAM), CD-ROMs, magnetic tapes, floppy disks, optical data storage devices, and carrier waves (such as data transmission through the Internet). The computer-readable recording medium may also be distributed over network-coupled computer systems so that the computer-readable code is stored and executed in a distributed fashion. Also, functional programs, code, and code segments for accomplishing the present invention can be easily construed by programmers skilled in the art to which the present invention pertains.

As set forth above, according to aspects of the present invention, management information such as an RPL generated by performing an LOW in a write-once information recording medium such as a DVD-R or the like and an RMD for recording management are managed to smoothly and efficiently use the medium. Thus the usage efficiency of the medium can be improved. Moreover, while described in the context of DVD-R, it is understood that aspects of the invention can be used in other write-once and/or rewritable media including Blu-Ray and HD DVD and other like media.

Although a few embodiments of the invention have been shown and described, it would be appreciated by those skilled in the art that changes may be made in these embodiments without departing from the principles and spirit of the invention, the scope of which is defined in the claims and their equivalents.

What is claimed is:

1. A write-once information recording medium in which a logical overwrite (LOW) can be performed, wherein the medium is used as at least one border, and a border closing area for recording last information at the time of closing each border is provided in at least one of a lead-in area in the medium, a border-in area and a border-out area of a border zone.

2. The write-once information medium of claim 1, wherein the last information is a copy of at least one of last recording management data at the time of closing the border and a last replacement list (RPL) of replacement lists (RPL) having replacement information based on the logical overwrite.

3. The write-once information medium of claim 2, wherein the copy is recorded in the border closing area at least one time.

4. The write-once information medium of claim 2, wherein the last recording management data comprises location information of the copy of the last RPL.

5. A recording/reproducing apparatus for writing data to a write-once information recording medium in which a logical overwrite (LOW) can be performed or reproducing data from the medium, comprising:
a writing/reading unit which writes the data to the medium used as at least one border and reads the data from the medium; and
a control unit which controls the writing/reading unit to write final information of each of a plurality of borders at the time of closing each border in at least one of a border closing area provided in a lead-in area of the medium, a border-in area of a border zone, and a border-out area of the border zone.

6. The recording/reproducing apparatus of claim 5, wherein the control unit controls the writing/reading unit to write a copy of at least one of last recording management data at the time of closing the border and a last RPL of replacement lists RPL having information on a replacement based on the logical overwrite (LOW) is recorded as the last information.

7. The recording/reproducing apparatus of claim 6, wherein the control unit controls the writing/reading unit to write the copy is recorded at least one time.

8. The recording/reproducing apparatus of claim 6, wherein the last recording management data comprises location information of the copy of the last RPL.

9. The recording/reproducing apparatus of claim 6, wherein the control unit controls the writing/reading unit to read the last information of each border is read from at least one of the border closing area provided in the lead-in area of the medium, the border-in area of the border zone, and the border-out area of the border zone, and controls reproduction of the data recorded in each border with reference to the read last information.

10. A recording/reproducing method for writing data to a write-once information recording medium in which a logical overwrite (LOW)can be performed or reproducing data from the medium, comprising:
when closing each border in the medium used as at least one border, recording last information of each of a plurality of borders in at least one of a border closing area provided in a lead-in area of the medium, a border-in area of a border zone, and a border-out area of the border zone.

11. The recording/reproducing method of claim 10, wherein the recording of the last information comprises recording a copy of at least one of last recording management data at the time of closing each border and a last RPL of replacement lists RPL having replacement information based on the logical overwrite (LOW) as the last information.

12. The recording/reproducing method of claim 10, wherein the recording of the last information comprises recording the copy at least one time.

13. The recording/reproducing method according to claim 11, wherein the last recording management data comprises location information of the copy of the last RPL.

14. The recording/reproducing method of claim 10, further comprising:
reading the last information of each border from at least one of the border closing area provided in the lead-in area of the medium, the border-in area of the border zone, and the border-out area of the border zone; and
reproducing data recorded in each border with reference to the read last information.

15. A write-once information recording medium comprising:
a lead-in area
at least one border;
a border closing area in the lead-in area;
a border-out area in a first border and any border subsequent to the first border;
a border-in area in any border subsequent to the first border; and
at least one last border information area used by a recording/reproducing apparatus to write last border information at a time of closing an associated border, the last border information comprising information on a logical overwrite (LOW) performed by the recording/reproducing apparatus in the medium;
wherein a last border information area for the first border is provided in the border closing area of the lead-in area and/or the border-out area of the first border; and
wherein a last border information area for any border subsequent to the first border is provided in the border-in area of any border subsequent to the first border and/or the border-out area of any border subsequent to the first border.

16. The medium of claim 15, wherein there is no border subsequent to the first border, such that the medium is a single-border medium,

17. The medium of claim 15, wherein there is at least one border subsequent to the first border, such that the medium is a multi-border medium.

18. The medium of claim 15, wherein the last border information comprises at least one copy of last recording management data (RMD) at the time of closing the associated border and/or at least one copy of a last replacement list (RPL) at the time of closing the associated border, the last RPL comprising information on any replacement of data by the LOW performed by the recording/reproducing apparatus up to the time of closing the associated border.

19. The medium of claim 18, wherein the last border information comprises multiple copies of the last RMD and/or multiple copies of the last RPL.

20. The medium of claim 18, wherein the last RMD comprises location information of a copy of the last RPL.

21. The medium of claim 18, wherein the last RPL further comprises defect information for replacement of defective data performed by the recording/reproducing apparatus in the medium up to the time of closing the associated border.

22. A recording/reproducing apparatus that writes data to a write-once information recording medium and/or reproduces data from the medium, the medium comprising a lead-in area, the apparatus comprising:
a writing/reading unit that writes data to the medium and reads data from the medium; and
a control unit that controls the writing/reading unit to write data to the medium so that the medium further comprises at least one border, a border closing area in the lead-in area, a border-out area in a first border and any border subsequent to the first border, and a border-in area in any border subsequent to the first border, controls the writing/reading unit to perform a logical overwrite (LOW) in the medium, and controls the writing/reading unit to write last border information at a time of closing an associated border in at least one last border information area, the last border information comprising information on the LOW performed by the writing/reading unit;
wherein a last border information area for the first border is provided in the border closing area of the lead-in area and/or the border-out area of the first border; and
wherein a last border information area for any border subsequent to the first border is provided in the border-in area of any border subsequent to the first border and/or the border-out area of any border subsequent to the first border.

23. The apparatus of claim 22, wherein the control unit controls the writing/reading unit to write the data to the medium so that there is no border subsequent to the first border, such that the medium is a single-border medium.

24. The apparatus of claim 22, wherein the control unit controls the writing/reading unit to write the data to the medium so that there is at least one border subsequent to the first border, such that the medium is a multi-border medium.

25. The apparatus of claim 22, wherein the control unit further controls the writing/reading unit to write, as the last border information, at least one copy of last recording management data (RMD) at the time of closing the associated border and/or at least one copy of a last replacement list (RPL) at the time of closing the associated border, the last RPL comprising information on any replacement of data by the LOW performed by the writing/reading unit up to the time of closing the associated border.

26. The apparatus of claim 25, wherein the control unit controls the writing/reading unit to write, as the last border information, multiple copies of the last RMD and multiple copies of the last RPL.

27. The apparatus of claim 25, wherein the last RMD comprises location information of a copy of the last RPL.

28. The apparatus of claim 25, wherein the control unit further controls the writing/reading unit to perform replacement of defective data in the medium; and
wherein the last RPL further comprises defect information for replacement of defective data performed by the writing/reading unit up to the time of closing the associated border.

29. The apparatus of claim 25, wherein the control unit further controls the writing/reading unit to read the last border information from the last border information area for the first border and any border subsequent to the first border, and controls the writing/reading unit to reproduce data from the first border and any border subsequent to the first border with reference to the last border information read by the writing/reading unit.

30. A recording/reproducing method of writing data to a write-once information recording medium and/or reproducing data from the medium, the medium comprising a lead-in area, the method comprising:
writing data to the medium so that the medium further comprises at least one border, a border closing area in the lead-in area, a border-out area in a first border and any border subsequent to the first border, and a border-in area in any border subsequent to the first border;
performing a logical overwrite (LOW) in the medium; and
writing last border information at a time of closing an associated border in at least one last border information area, the last border information comprising information on the LOW performed in the medium;
wherein a last border information area for the first border is provided in the border closing area of the lead-in area and/or the border-out area of the first border; and
wherein a last border information area for any border subsequent to the first border is provided in the border-in area of any border subsequent to the first border and/or the border-out area of any border subsequent to the first border.

31. The method of claim 30, wherein the writing of data to the medium comprises writing data to the medium so that there is no border subsequent to the first border, such that the medium is a single-border medium.

32. The method of claim 30, wherein the writing of data to the medium comprises writing data to the medium so that there is at least one border subsequent to the first border, such that the medium is a multi-border medium.

33. The method of claim 30, wherein the writing of the last border information comprises writing, as the last border information, at least one copy of last recording management data (RMD) at the time of closing the associated border and/or at least on copy of a last replacement list (RPL) at the time of closing the associated border, the last RPL comprising information on any replacement of data by the LOW performed up to the time of closing the associated border.

34. The method of claim 33, wherein the writing of the last border information comprises writing multiple copies of the last RMD and/or multiple copies of the last RPL.

35. The method of claim 33, wherein the last RMD comprises location information of a copy of the last RPL.

36. The method of claim 33, further comprising performing replacement of defective data in the medium;
wherein the last RPL further comprises defect information for replacement of defective data performed up to the time of closing the associated border.

37. The method of claim 33, further comprising:
reading the last border information from the last border information area for the first border and any border subsequent to the first border; and
reproducing data from the first border and any border subsequent to the first border with reference to the last border information read in the reading of the last border information.

38. A computer-readable medium encoded with processing instructions for implementing a recording/reproducing method, performed by a computer, of writing data to a write-once information recording medium and/or reproducing data from the medium, the medium comprising a lead-in area, the method comprising:
writing data to the medium so that the medium further comprises at least one border, a border closing area in the lead-in area, a border-out area in a first border and any border subsequent to the first border, and a border-in area in any border subsequent to the first border;
performing a logical overwrite (LOW) in the medium; and
writing last border information at a time of closing an associated border in at least one last border information area, the last border information comprising information on the LOW performed in the medium;
wherein a last border information area for the first border is provided in the border closing area of the lead-in area and/or the border-out area of the first border; and
wherein a last border information area for any border subsequent to the first border is provided in the border-in area of any border subsequent to the first border and/or the border-out area of any border subsequent to the first border.
